(19) United States
(12) Patent Application Publication
(10) Pub. No.: US 2018/0307555 A1
(43) Pub. Date: Oct. 25, 2018

(54) TRANSFER OF DATA WITH CHECK BITS

(71) Applicant: Cirus Logic International Semiconductor Limited, Edinburgh (GB)

(72) Inventor: Willem ZWART, Edinburgh (GB)

(73) Assignee: Cirus Logic International Semiconductor Limited., Edinburgh (GB)

(21) Appl. No.: 15/771,000

(22) PCT Filed: Jun. 24, 2016
(86) PCT No.: PCT/GB2016/051913

§ 371 Date: Apr. 25, 2018

Related U.S. Application Data
(60) Provisional application No. 62/246,972, filed on Oct. 27, 2015.

(51) Int. Cl. G06F 11/10; H04L 1/00

(52) U.S. Cl. CPC G06F 11/1004; H04L 1/0041; H04L 1/0059; H04L 1/0061; H04L 1/0045

(57) ABSTRACT

A data transmitter is configured for transmitting multiple payload data streams in a frame format, wherein each frame comprises multiple rows, and each row comprises multiple bit slots. The data transmitter comprises: configuration storage circuitry, for storing frame format configuration data; an input, for receiving the multiple payload data streams; data multiplexing circuitry, for Combining the multiple payload data streams in accordance with the stored frame format configuration data to form a combined payload data stream; and redundancy code generator circuitry, for receiving the combined payload data stream, and generating check bit data therefrom. The data multiplexing circuitry is further configured for multiplexing the combined payload data stream and the check bit data into data for transmission in said frame format.

This invention relates to the transfer of data, and including check bits in the data transmitted.

### BACKGROUND

There are many situations in which it is desired to transfer data from one device to another. For example, digital audio accessory devices, such as digital headsets, are connected to a host device through a cable. Similarly, audio processing devices may be connected together within a larger product.

Though the digital data interface may be designed to be as robust as possible, various events, such as interference from nearby radio devices, or the unplugging of the interface cable, may cause data errors or interruptions on the digital audio stream.

These errors or interruptions might be beyond the control of the user and/or might not be readily detectable by the user.

In general data transmission systems, wanted data (also referred to useful data or payload data) may be supplemented with a set of redundant data, allowing the receiving device to detect whether the received data was received without errors

In common solutions, a block of wanted data is protected by a block of redundant data, such as a CRC (Cyclic Redundancy Check) or a FEC (Forward Error Correcting) Code, which is being transferred after the transfer of the block of original data. However, since the wanted data is then not generally processed until after the redundant data has been received, this introduces an additional latency before the received data is processed, and this may be undesirable, for example when the data is a real-time audio data stream, especially where the data is used for ambient noise cancellation or beamforming.

### SUMMARY

According to a first aspect of the invention, there is provided a data transmitter for transmitting multiple payload data streams in a frame format, wherein each frame comprises multiple rows, and each row comprises multiple bit slots, the data transmitter comprising:
configuration storage circuitry, for storing frame format configuration data;
an input; for receiving the multiple payload data streams;
data multiplexing circuitry; for combining the multiple payload data streams in accordance with the stored frame format configuration data to form a combined payload data stream; and
redundancy code generator circuitry, for receiving the combined payload data stream, and generating check bit data therefrom;
wherein the data multiplexing circuitry is further configured for multiplexing the combined payload data stream and the check bit data into data for transmission in said frame format.

According to a second aspect of the invention, there is provided a data receiver for receiving data in a frame format, wherein each frame comprises multiple rows, and each row comprises multiple bit slots, the receiver comprising:
configuration storage circuitry for storing frame format configuration data;
data selection circuitry, for extracting payload data and received check bit data from the received data according to the stored frame format configuration data;
a redundancy code generator, for generating from the payload data a stream of locally generated check bit data; and
data error checking circuitry, for comparing the locally generated check bit data with the extracted received check bit data, and for generating an error flag if the comparison identifies a difference between the locally generated check bit data and the extracted received check bit data.

This has the advantage that, in the event of data errors, action can be taken to mitigate the errors with low delay.

### BRIEF DESCRIPTION OF THE DRAWINGS

For a better understanding of the present invention; and to show how it may be put into effect, reference will now be made, by way of example, to the accompanying drawings, in which:

FIG. 1 illustrates a product containing audio devices;

FIG. 2 illustrates schematically the data transmission and reception circuitry in a pair of devices;

FIG. 3 illustrate the structure of a frame of transmitted data;

FIG. 4 illustrates in more detail the frame structure shown in FIG. 3;

FIG. 5 illustrates in more detail one pa the data transmission and reception circuitry in a pair of devices;

FIG. 6 illustrates the operation of the circuitry of FIG. 5;

FIG. 7 illustrates in more detail one part of the data transmission circuitry in FIG. 5;

FIG. 8 illustrates the circuitry of FIG. 7 in further detail;

FIG. 9 illustrates in more detail one part of the data reception circuitry in FIG. 5;

FIG. 10 illustrates the circuitry of FIG. 9 in further detail;

FIG. 11 illustrates a Redundant Code Generator block in the circuitry of FIG. 7 or 8;

FIG. 12 illustrates a Redundant Code Generator block in the circuitry of FIG. 9 or 10;

FIGS. 13 and 14 illustrate possible forms of a part of the circuitry in FIGS. 7 and 8 or FIGS. 9 and 10;

FIG. 15 illustrates in more detail one part of the data transmission and reception circuitry in a pair of devices, in an alternative embodiment;

FIG. 16 illustrates the operation of the circuitry of FIG. 15, in one embodiment; and

FIG. 17 illustrates the operation of the circuitry of FIG. 15; in another embodiment.

### DETAILED DESCRIPTION

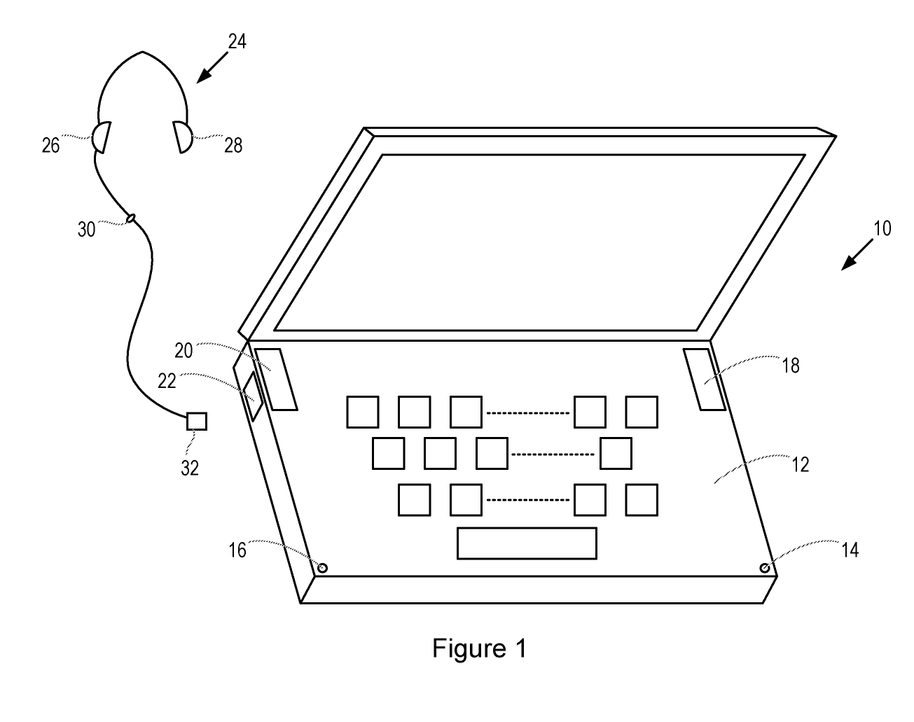

FIG. 1 illustrates a laptop computer 10, as an example of a product including an audio system operating in accordance with the methods described herein.

The laptop computer 10 has an upper internal surface 12, which includes a keyboard. The surface 12 also includes sound inlet apertures 14, 16 that allow external sounds to be picked up by microphones within the body of the laptop computer 10. The surface 12 also includes sound outlet apertures 18, 20 that allow the egress of sounds generated by loudspeakers within the body of the laptop computer 10. The laptop computer 10 also includes at least one inlet/outlet port 22 for receiving a removable connector that can also be used to transmit or receive audio data. For example, the port 22 can be a socket for receiving a 3.5 mm audio jack, or can be a USB-C socket, allowing a headset or other device to be connected to the laptop computer 10.

As an example, FIG. 1 shows a headset 24, which includes a pair of earphones 26, 28, which each include respective speakers. The headset 24 also includes a microphone 30 for picking up the wearer's voice. The headset 24 has a jack 32 for connection to the socket 22 of the computer 10.

The various microphones, speakers, and other audio processing devices in the system are connected, for example, to an audio codec (not shown) within the laptop computer 10. The audio codec is able to manipulate the audio data as required, for example to receive audio data streams from multiple microphones, generate one or more streams of processed output data output therefrom, and output digital audio streams to speakers to be rendered.

Although the laptop computer 10 is illustrated by way of an example, it will be appreciated that the system described herein can be used in any suitable product or end-user apparatus, such as notebook or tablet computers, smartphones, games consoles, television sets, in-car entertainment systems, home cinema systems, or the like.

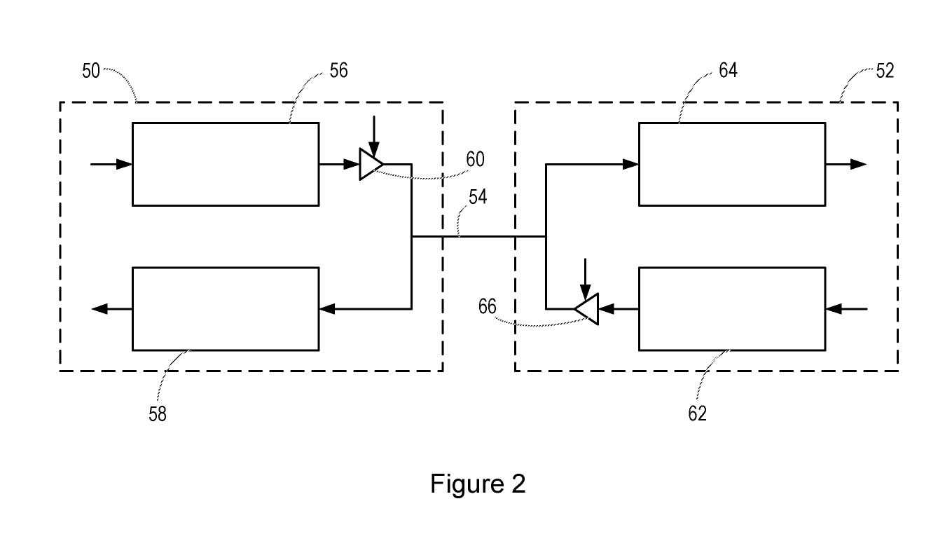

FIG. 2 shows the general form of data transmission and reception circuitry in a pair of devices according to one embodiment.

Specifically, FIG. 2 shows a first device 50 and a second device 52, connected by a wired link 54. The wired link 54 may comprise a single wire, or a pair of wires driven differentially, or may be some arrangement with multiple wires. In this illustrated embodiment, there is half-duplex bidirectional communication between the first device 50 and the second device 52. That is, only one of the two devices can be transmitting at any time.

The first device 50 comprises transmitter circuitry 56 and receiver circuitry 58, and a driver 60 is enabled at times at which the first device 50 is allowed to transmit data and disabled otherwise to allow data to be received by receiver circuitry 58. Similarly, the second device 52 comprises transmitter circuitry 62 and receiver circuitry 64, and a driver 66 is enabled at times at which the second device 52 is allowed to transmit data and disabled otherwise.

As mentioned above, in one example, the method described herein may be used in a situation in which a wire is used for half-duplex bidirectional communication.

In this example, one of the two devices is designated as the “master” device, while the other is designated as the “slave” device.

In this example, signals are transmitted in frames, which are divided into sub-frames.

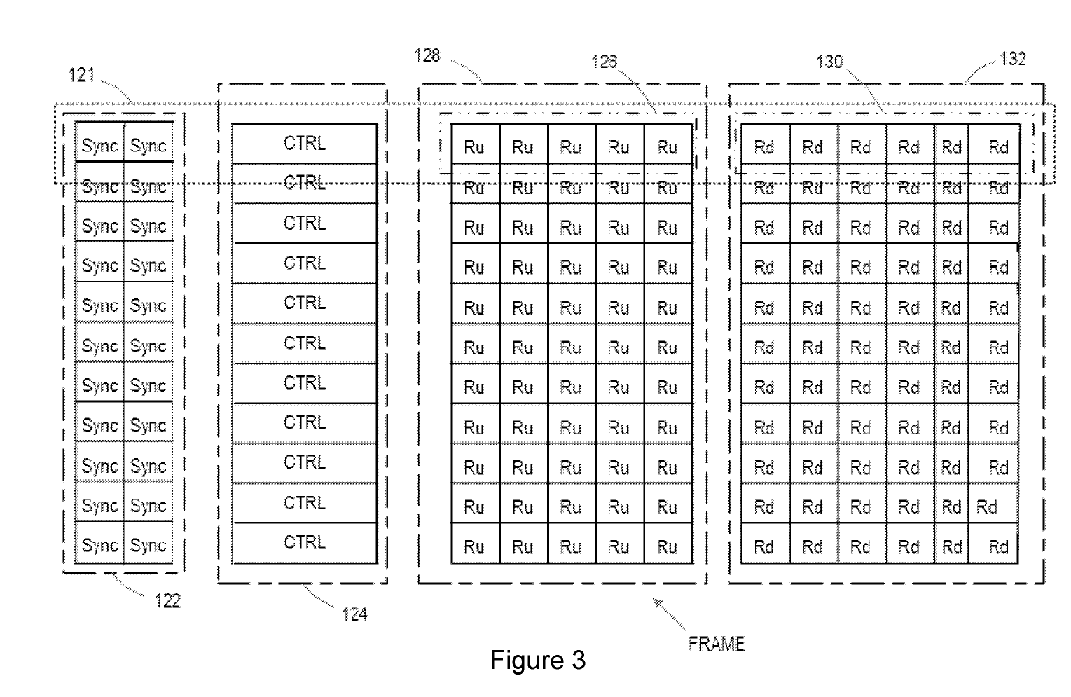

FIG. 3 shows an example of the data transfer in a frame 120. In this example, there are a number of rows 121 in the frame, and each row contains bit slots that are reserved for:
transmitting synchronization data from the master to the slave (i.e. “down”);
transmitting isochronous data (for example audio data) from the master to the slave;
transmitting isochronous data from the slave to the master (i.e. “up”); and
transmitting asynchronous control data, either from the master to the slave, or from the slave to the master.

Synchronization data is data flowing from the master device to the slave device, and used to establish synchronization between the devices, to allow operation of the communications interface. Synchronization data is made up of synchronization data bits. A synchronization data bit slot is a time window during which the communications interface can transfer a single synchronization data bit, and a synchronization subframe 122 is the subset of the frame grouping together all the synchronization data bit slots of the frame.

Control data is data flowing between devices, required for the operation of the communications interface and other miscellaneous functions on the respective devices. Control data is made up of control data bits, which are the atomic units of information in the control data. A control data bit slot is a time window during which the communications interface can transfer a single control data bit, and a control subframe 124 is the subset of the frame grouping together all the control data bit slots of the frame.

Useful data can be transferred in both directions. The group of bit slots allocated for data transfer from the slave to the master during each row is referred to as an UP transport window 126, and the UP transport subframe 128 is the subset of the frame grouping together all the bit slots in one frame allocated for data transfer from the slave to the master. The group of bit slots allocated for data transfer from the master to the slave during each row is referred to as a DOWN transport window 130, and the DOWN transport subframe 132 is the subset of the frame grouping together all the bit slots in one frame allocated for data transfer from the master to the slave.

In this example, the sequence is that each row contains two sync symbols, Sync, transmitted from the master to the slave, then a control symbol, CTRL, which may be transmitted in either direction, then a series of data symbols Ru transmitted from the slave to the master, and a series of data symbols Rd transmitted from the master to the slave. However, the order of the sync symbols, the control symbol(s), and the data symbols may be different in different embodiments.

The number of data symbols Ru transmitted up from the slave to the master, and the number of data symbols Rd transmitted down from the master to the slave are configurable. As discussed below, each UP transport window may contain a mix of bit slots for wanted or payload data bits and check bit data, and each DOWN transport window may contain a mix of bit slots for wanted or payload data bits and check bits respectively (and possibly empty or unallocated bit slots).

A propagation delay applies to transmissions in both directions. Thus, there is a delay at each device when the direction of data flow is changed.

A row may be defined as the group of consecutive bit slots in a frame that contains one synchronization pattern and/or one pair of changes in the direction of data flow.

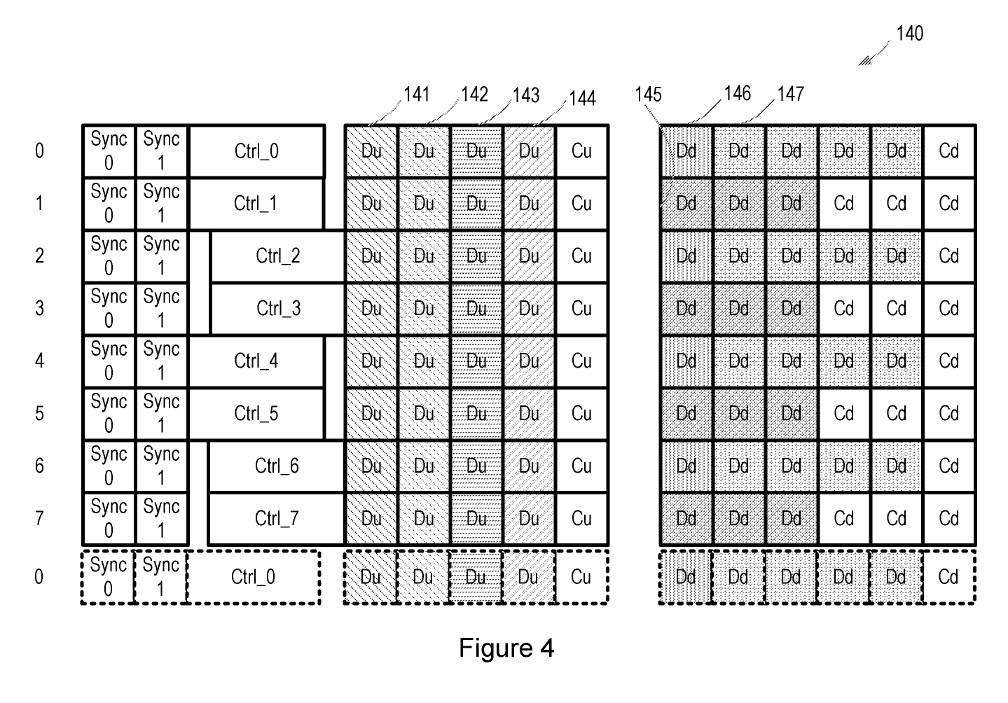

FIG. 4 shows an example, in which there are 8 rows in the frame 140, numbered 0-7. As in FIG. 3, each row contains two sync symbols (Sync_0 and Sync_1), transmitted from the master to the slave, then a control symbol Ctr1_0, Ctr1_1, Ctr1_2, etc, which may be transmitted in either direction, then a series of data symbols transmitted from the slave to the master, and a series of data symbols transmitted from the master to the slave. In this example, for illustrative purposes only, in each sub-frame there are five data symbols transmitted from the slave to the master, and six data symbols transmitted from the master to the slave.

In order to illustrate the handling of the delay at each device when the direction of data flow is changed, FIG. 4 shows the situation where the control symbols Ctr1_0, Ctr1_1, Ctrl_4, and Ctr1_5 in the rows numbered 0, 1, 4 and 5 of the frame respectively are transmitted down from the master device to the slave device. Therefore, these control symbols follow immediately after the sync symbols that are transmitted from the master to the slave, and there is a time gap after the control symbol before the data symbols that are transmitted from the slave to the master to avoid data collisions due to transmission and propagation delays when changing the direction of data flow. Conversely, the control symbols Ctr1_2, Ctr1_3, Ctr1_6 and Ctr1_7 in the rows numbered 2, 3, 6 and 7 of the frame respectively are transmitted from the slave device to the master device. Therefore, these control symbols follow after the sync symbols that are transmitted from the master to the slave with a time gap to allow for the changed direction of data flow, and the data symbols that are transmitted from the slave to the master follow immediately after the control symbol.

Because there are only two such reversals of the data transfer direction in each row, the total time associated with the transmission delay is advantageously smaller than it would be with more direction changes. Put another way, this ensures that a maximally large portion of the period of each row can be used effectively for transferring data, inherently optimizing the number of data symbols that can be transferred per unit of time, given the constraints for latency and the required overhead to synchronize two devices on either side of the interface. As a consequence of the ordering of the symbol slots as described, the direction of the data in the control symbol has no impact on the maximal number of data symbols that can be transferred per unit of time.

In some embodiments the sync subframe may be configured to occur immediately before the down transport window in each row. Since the sync symbols are always transmitted down from master to slave, this arrangement retains the advantage of only a single pair of direction reversals per row.

FIG. 4 also shows that the data symbols transmitted up from the slave to the master include wanted traffic data symbols, Du, but also include check bits, Cu, which can be used by the receiver to validate the received data. Similarly, the data symbols transmitted down from the master to the slave include wanted traffic data symbols, Dd, but also include check bits, Cd, which can be used by the receiver to validate the received data. The arrangements of check bits Cu, Cd amongst the groups of bits Ru, Rd respectively can be configured as required.

In this purely illustrative example, FIG. 4 shows that each row of data symbols transmitted up from the slave to the master includes 4 wanted traffic data symbols Du and 1 check bit (Cu). Thus, the up transport subframe of the frame 140 contains 32 wanted traffic data symbols Du and 8 check bits (Cu). Each even-numbered row of data symbols transmitted down from the master to the slave includes 5 wanted traffic data symbols Dd and 1 check bit (Cd), while each odd-numbered row of data symbols transmitted from the master to the slave includes 3 wanted traffic data symbols Dd and 3 check bits (Cd). Thus, the down transport subframe of the frame 140 contains 32 wanted traffic data symbols Dd and 16 check bits Cd, providing more robust error correction for the data transmitted from the master to the slave, but at a cost of lower efficiency of usage of the time available for transmitting data.

The different shading of the four Du columns of the up transport window in FIG. 4 illustrates that the wanted traffic data symbols Du transmitted from the slave to the master may include symbols 141 from a first Pulse-Density Modulation (PDM) data stream, symbols 142 from a second PQM data stream, symbols 143 from a third PQM data stream and symbols 144 from a fourth PDM data stream that have been multiplexed together such that symbols from each PDM data stream are allocated the same position in each row. Similarly, FIG. 4 also shows that the wanted traffic data symbols Dd transmitted from the master to the slave may include symbols 145 from a first Pulse-Density Modulation (PDM) data stream, symbols 146 from a second Pulse-Density Modulation (PDM) data stream, and symbols 147 from a third Pulse-Density Modulation (PDM) data stream that have been multiplexed together such that symbols from each PDM data stream are allocated different positions that differ from at least one row to another.

The arrangement shown for the traffic data symbols Du, where there is one bit from each stream per row, avoids having to wait for one or more row before bursting the PDM bits, and thus helps to minimise the latency. The arrangement shown for the traffic data symbols Dd, where several bits from each stream are sent consecutively, may be more compatible with upstream processing timing and structure.

The number of bits in a frame that are allocated to a stream can be determined by the required data rate of that stream. For high PDM data rates, it may be necessary to allocate two or more bit slots in each row to that stream, but for other streams a slower data rate is adequate.

Using a single-bit oversampled format such as PDM for audio data transmission with a sample rate of say 1.5 Mb/s, or even say multi-bit oversampled data at 375 ks/s gives an inherent advantage in terms of latency over equivalent multi-bit data at a base sample rate of say 48 ks/s. Thus any errors in transmission can be responded to with a lower latency once detected. However this possibility of rapid reaction is squandered if the error-checking only occurs once per frame.

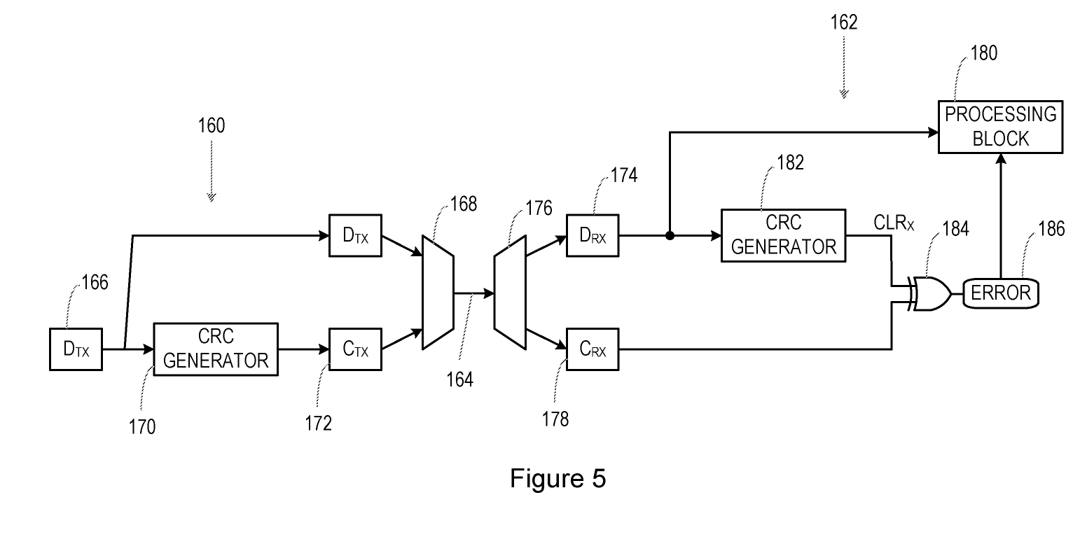

FIG. 5 shows the form of transmit-receive circuitry for generating and including the check bits on the transmit side, and for using the check bits on the receive side.

Thus, for the sake of clarity, FIG. 5 shows only a part of the transmit circuitry 160 in one device and a part of the receive circuitry 162 in another device, with the two devices connected by a wired link 164. To allow bidirectional communication as described above, transmit circuitry and receive circuitry can be provided in each of the two devices.

FIG. 5 shows the transmitter 160 including a source 166 of wanted traffic data D_{TX}, with that data being applied to one input of a multiplexer 168. As described with reference to FIG. 4, the wanted traffic data D_{TX} may be made up of data from multiple data streams, for example PDM data streams, that have been multiplexed together.

The wanted traffic data D_{TX} is also applied to an input of a Redundancy Code (or Cyclic Redundancy Check (CRC) bit) Generator (RCG) 170, which generates check bits C_{TX} 172. The check bits C_{TX} are applied to the other input of the multiplexer 168.

A data stream is formed by multiplexing the wanted traffic data D_{TX} and the check bits C_{TX} in the intended bit slots, and this is transmitted over the wire 164 to the receiver. Typically, the check bits C_{TX} will be transmitted immediately after the wanted traffic data D_{TX} used in generating the check bits, but it is also possible to delay the traffic data so that the check bits are transmitted before the wanted traffic data D_{TX} used in generating them.

The receiver includes a demultiplexer 174 for separating the received traffic data D_{RX} and received check bits C_{RX} based on knowledge of the bit slots within each sub-frame in which each is intended to appear.

The received traffic data D_{RX} is passed to an audio processing block 180 for further processing. For example, the received traffic data D_{RX} may be passed to a playback device.

The received traffic data D_{RX} is also passed to a CRC bit generator 182, having the same form as the CRC bit generator 170 in the transmitter device, and intended to be operated with a degree of synchronization with the CRC bit generator 170, as discussed below.

If the CRC bit generators 170, 182 are operating with the intended degree of synchronization, and there have been no errors in the transmission of the data, the output of the CRC bit generator 182 will be the same as the output of the CRC bit generator 170, which will in turn be the same as the check bits C_{Rx} received in the receiving device.

However, any error in the transmission of the data will mean that the output sequence of the CRC bit generator 182 may become different from the received check bits C_{RX}.

In order to confirm whether there have been any errors, the output CLR_{X} from the CRC bit generator 182 and the received check bits C_{RX} are applied to respective inputs of an XOR date 184 or equivalent. The output of the XOR gate 184 is connected to an error detection block 186 for determining if there is any difference between them. If there have been no errors in the transmission of the data, the output of the CRC bit generator 182 will be the same as the check bits C_{RX} and the output of the XOR gate 184 will be low. A high signal output from the XOR date 184 indicates that the output of the CRC bit generator 182 is different from the check bits C_{RX} and hence that there has been an error in the transmission of the data.

In fact, any error in the transmission of the data will mean that each bit CLR_{X} output from the CRC bit generator 182 will effectively be a random bit, i.e. uncorrelated with C_{RX}. So, each check bit generated by the CRC bit generator 182 thereafter will have on average a 50% probability of being correct, and a 50% probability of being incorrect. This means that, after 5 comparisons by the XOR gate 184, there is on average a 31 in 32 chance that the error will have been detected, without needing to get to the end of the frame. After 10 check bits, there is on average a 99.9% probability that any error would have been detected.

In the event of an error, remedial or mitigating action can be taken. For example, a signal can be sent to the processing block 180 to mute the audio signal, either abruptly or with some ramped attenuation.

Alternatively the processing block may choose not to render the received and plausibly corrupted audio, but to temporarily predict or extrapolate the value of the audio signal based on preceding audio samples from immediately or from a short time before when an error was first flagged, and then attenuate the extrapolated waveform down to zero over a number of clock periods.

In some cases the downstream signal processing may unavoidably result in some small additional latency, and the muting or similar may be implemented on the signal after this processing delay. For instance the signal may be delayed by a single bit slot period due to it being retimed onto a following bit clock edge after some processing, for example into a multi-bit format for feeding a multi-bit oversampled output digital-to-analogue converter and driver amplifier. In some examples, the overall latency budget may allow a longer and deliberate delay before the audio signal is used, and this may allow several check bits to be processed before the audio signal is actually used, giving a greater chance of catching a data error before the corresponding audio sample is actually used to provide an audible output.

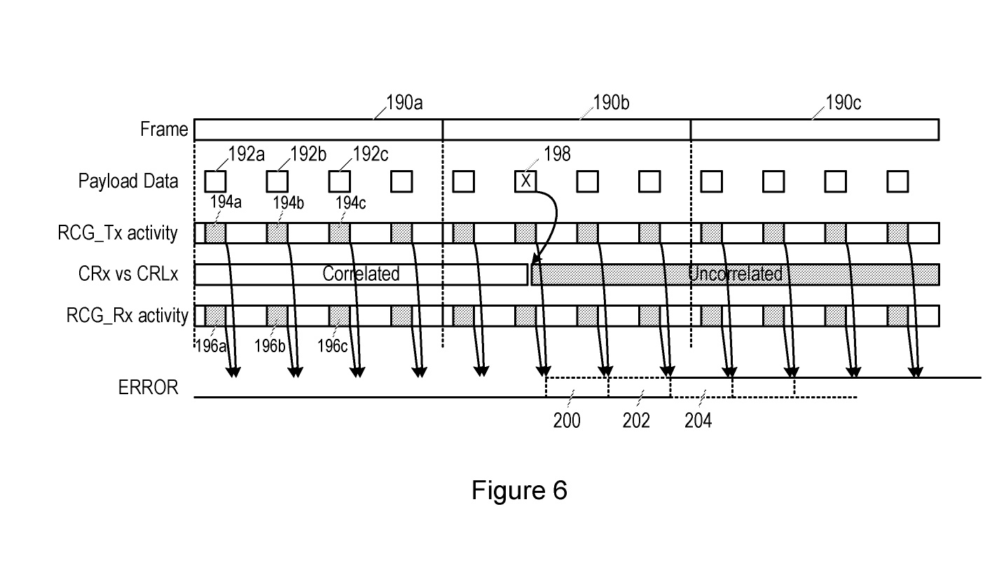

FIG. 6 illustrates the operation of the system of FIG. 5, in one example situation. Specifically, FIG. 6 shows an example of the operation over several frames 190a, 190c, 190c, where each frame includes 4 rows for the purposes of illustration, and each of these rows includes some payload data 192a, 192b, 192c, etc for transmission in the direction illustrated.

The Redundancy Code Generator on the transmit side (RCG_Tx) is therefore also active during each row, generating one check bit (in this illustrated example, although multiple check bits may be generated per row, as mentioned previously) 194a, 194b, 194c, etc. The Redundancy Code Generator on the receive side (RCG_Rx) is also active during each row, again generating one check bit 196a, 196b, 196c, etc per row. The error detection block on the receive side compares the check bits C_{RX} received from the transmitter with the check bits CLR_{X} from RCG_Rx. When there have been no errors in the received data stream, the check bits C_{RX} and CLR_{X} are correlated, and so the comparison shows that there has been no error.

FIG. 6 shows an error (marked by an X) in the transmission of one row 198 of payload data. From that point onwards, the check bits CLR_{X} generated by RCG_Rx at the receive side will become uncorrelated with the check bits C_{RX} received from the transmitter.

As illustrated at 200 and 202, the effect of this is that the subsequent check bits CLRₓ generated by RCG_Rx at the receive side may be equal to the check bits C_{RX} received from the transmitter, or may be different. When a check bit CLₓ generated by RCG_Rx at the receive side is first unequal to the corresponding check bit C_{RX} received from the transmitter, illustrated at 204, the error detection block in the receiver sets a flag, which is latched, and the subsequent processing of the received data is handled appropriately. Further check bits generated by RCG_Rx at the receive side will remain uncorrelated with the corresponding check bits C_{RX} received from the transmitter, and may be equal to them or may be different, but the subsequent processing of the received data is still handled in a way that reflects the fact that an error has been detected.

In contrast to some other error detection schemes, the Redundancy Code Generator is not reset every row: the state of the Redundancy Code Generator is preserved from one row to another, despite any dead period in which data is not transmitted in a particular direction. Thus check bits generated in later rows are still sensitive to errors that may have occurred in earner rows. Thus even if an error is missed by chance on the first check bits to be compared, there is a good chance the error will be detected by later check bits.

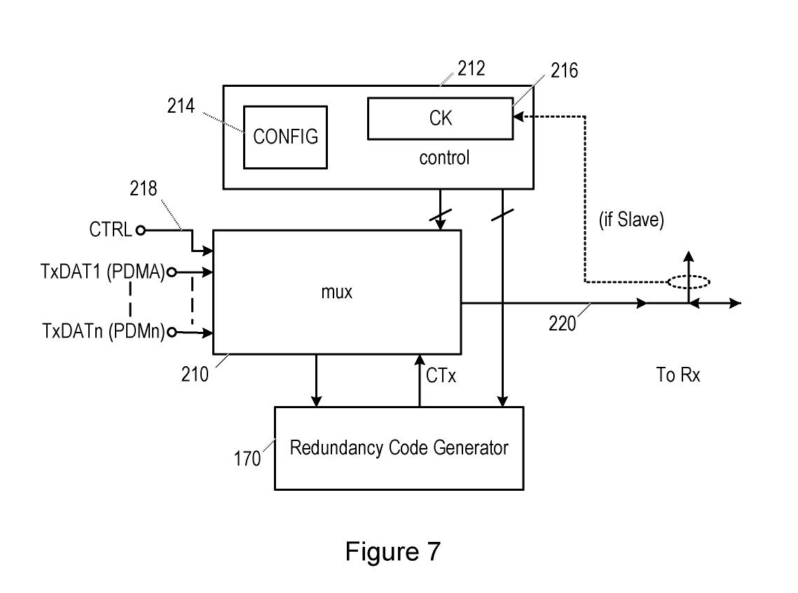

FIG. 7 is a block diagram, illustrating in more detail a part of the transmitter circuitry 160 as shown in FIG. 5. Specifically, FIG. 7 shows multiple payload data streams TxDATA1, . . . , TxDATn (which in this illustrated example are PDM data streams PDMA, . . . , PDMn) being passed to data multiplexing circuitry 210.

A configuration and control block 212 stores frame format configuration data 214 and includes a clock signal source 216. When the transmitter is located within a master device, the dock signal may be generated within the transmitter circuitry or received from another source located within the device. The configuration data may be pre-loaded when the device is started up, or may be initialised later from an internal or external data store.

When the transmitter is located within a slave device, the dock signal may be recovered from a data stream received from the master device, and the configuration data may be received from the master device in data that is sent on initialisation or a subsequent re-initialisation.

The stored frame format configuration data 214 may include data relating to multiple possible configurations, and it is then possible to select between the stored configurations, but only one such configuration is described here,

The data multiplexing circuitry 210 receives the payload data streams, and multiplexes them according to the currently stored or selected configuration data into a combined payload data stream. The combined payload data stream is applied to the transmitter side Redundancy Code Generator 170, which generates check bit data CTx from the combined payload data stream.

The data multiplexing circuitry 210 then further multiplexes the combined payload data stream and the check bit data CTx (plus any control data 218) into data 220 for transmission in the required frame format. In this illustrated configuration, the frame format comprises rows of bit slots, with specific bit slots being assigned to respective data streams, and with at least one check bit per row of the frame. The control data (CTRL) 218 for transmission in the Control Data bit slots mentioned above may be used to convey commands from master to slave, which may comprise sequences of bits (transmitted in successive rows) denoting the address and desired contents of various registers in the slave used to store configuration information, for example to mute or activate the outputs. The master may also request status data from the slave to be transmitted from the slave in later control bit slots, or a slave transmitter may independently send status data or fault flags. The control bits may be generated by control circuitry 212 or some other circuitry or processor in the transmitting device.

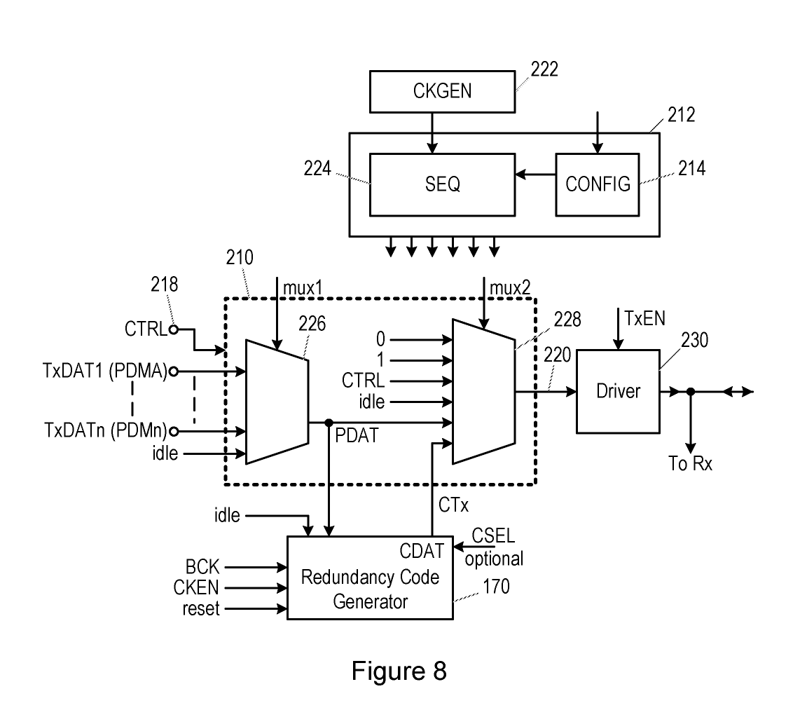

FIG. 8 is a more detailed block diagram of one embodiment of the circuitry shown in FIG. 7.

In the embodiment shown in FIG. 8, a separate clock generator 222 generates a clock signal, and a sequencer 224 uses the clock signal and the configuration data supplied by the configuration data store 214 to determine a sequence of bits to be allocated to particular bit slots in the rows of each frame.

A first multiplexer 226 in the data multiplexing circuitry 210 receives the payload data streams TxDATA1, . . . , TxDATn (which also in this illustrated example are PDM data streams PDMA, . . . , PDMn), and multiplexes them together with predetermined idle values if there is no payload data to transmit, according to a first multiplexer control signal mux1 into the combined payload data stream PDAT. The combined payload data stream PDAT is applied to the transmitter side Redundancy Code Generator (RCG) 170, which generates check bit data CTx from the combined payload data stream. The RCG 170 may also receive a clock BCK at the bit-slot rate and control inputs comprising an enable signal CKEN to enable clocking only during the transmission portion of each row of data or when a check bit needs to be transmitted, and a reset input to set the initial state of the RCG to a predefined state on start-up or any subsequent reinitialisation. In some embodiments discussed below there may be a control input CSEL to read out chosen recent values of CTx already stored within the RCG. The RCG 170 may also receive a fixed or non-fixed input signal “idle” which is used to supply suitable dummy data to the RCG 170 when being clocked in bit slots not corresponding to valid PDAT data to transmit. These clocks and control signals may be generated by control circuitry 212 or by other circuitry in the transmitting device.

A second multiplexer 228 in the data multiplexing circuitry 210 receives the combined payload data stream PDAT, the check bit data CTx, control data CTRL, “0” and “1” synchronization data values, and predetermined idle values for use if there is no data to transmit in a particular bit slot, and it multiplexes them together according to a second multiplexer control signal mux2 to form the output data stream 220.

The output data stream is applied to a driver 230, which allows the transmitter circuitry to transmit under the control of an enable signal TxEN when that device is acting as the transmitter on the half-duplex link. The driver 230 may include a scrambler for altering the positions of transmitted bits in the transmitted bit stream.

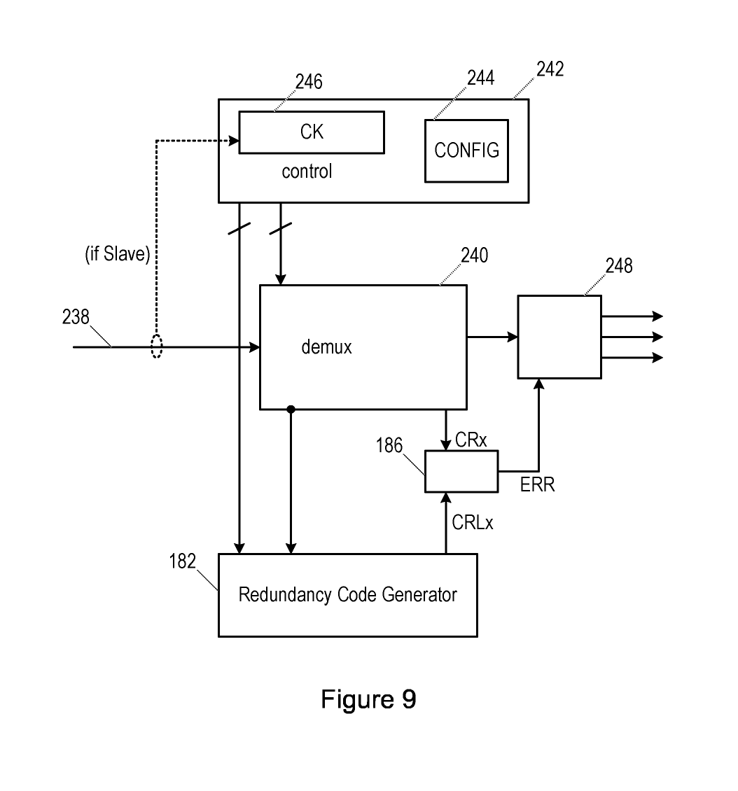

FIG. 9 is a block diagram, illustrating in more detail a part of the receiver circuitry 162 as shown in FIG. 5. Specifically, FIG. 9 shows the received data stream 238 being passed to demultiplexing circuitry 240.

A configuration and control block 242 stores frame format configuration data 244 and includes a clock signal source 246. When the receiver is located within a master device, the clock signal may be generated within the receiver circuitry or received from another source located within the device. The configuration data may be pre-loaded when the device is started up, or may be initialised later from an internal or external data store.

When the receiver is located within a slave device, the clock signal may be recovered from a data stream received from the master device, and the configuration data may be received from the master device in data that is sent on initialisation or a subsequent re-initialisation.

The stored frame format configuration data 244 may include data relating to multiple possible configurations, and it is then possible to select between the stored configurations, but only one such configuration is described here.

The demultiplexing circuitry 240 receives the payload data streams, and demultiplexes them according to the currently stored or selected configuration data to obtain a payload data stream. The payload data stream is applied to the receiver side Redundancy Code Generator 182, which generates check bit data CRLx from the payload data stream,

The demultiplexing circuitry 240 also obtains from the received data the received check bit data CRx. The generated check bit data CRLx and received check bit data CRx are applied to the error detecting block 186. In the event that an error is detected, a signal (ERR) is sent to a signal processing block 248, where it affects the handling of the received data.

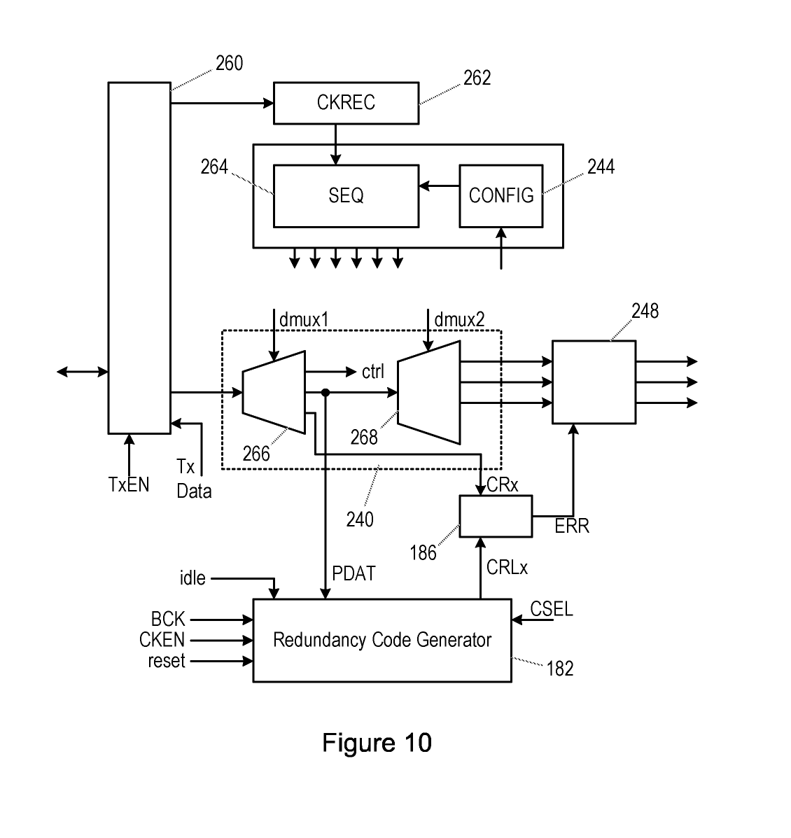

FIG. 10 is a more detailed block diagram of one embodiment of the circuitry shown in FIG. 9.

In the embodiment shown in FIG. 10, received data is passed through an input-output block 260 when the enable signal TxEN indicates that that device is acting as the receiver on the half-duplex link, and there is no data (Tx Data) for transmission.

The input-output block 260 may include a de-scrambler for altering the positions of received bits in the received bit stream to compensate for scrambling of the bit stream that may have been performed in the upstream transmitter at the other end of the wired link.

In the illustrated slave device, the received data is passed to a clock recovery circuit 262 to obtain a clock signal, and a sequencer 264 uses the clock signal and the configuration data supplied by the configuration data store 244 to identify the type of bits allocated to particular bit slots in the rows of each received frame.

A first demultiplexer 266 in the demultiplexing circuitry 240 extracts the payload data stream PDAT. The payload data stream is applied to the receiver side Redundancy Code Generator 182, which generates the check bit data CRLx from the payload data stream. The RCG 182 may also receive a clock BCK at the bit-slot rate and control inputs comprising an enable signal CKEN to enable clocking only during the receive portion of each row of data or when a check bit needs to be generated, and a reset input to set the initial state of the RCG to a predefined state consistent with that set on the transmitter RCG on start-up or any subsequent reinitialisation. In some embodiments discussed below there may be a control input CSEL to read out chosen recent values of CRLx already stored within the RCG. The RCG 182 may also receive a fixed or non-fixed input signal “idle” which is used to supply suitable dummy data to the RCG 182 when being clocked in bit slots not corresponding to received PDAT data. These clocks and control signals may be generated by control circuitry 212 or by other circuitry in the transmitting device.

The first demultiplexer 266 also obtains the control data (ctrl) transmitted in the control bit slots and also extracts the check bit data CRx from the received data stream, and forwards the received check bit data CRx to the error detecting block 186.

A second demultiplexer 268 may fully demultiplex the received data into the individual data streams that were multiplexed together in the transmitter, or may output the payload data in a single time-multiplexed stream. The output payload data is sent to the processing circuitry 248. Where the output of the second demultiplexer 268 is a single time-multiplexed stream, the separation into the individual data streams may take place in the processing circuitry 248.

The processing performed in the processing circuitry 248 may take any desired form. When an error signal is generated by the error detecting block 186, the processing performed in the processing circuitry 248 may be modified accordingly.

The processing performed in the processing circuitry 248 may be performed immediately each bit of the output payload data is received, that is without any deliberate delay. Alternatively, the data may be deliberately delayed by one or more bit dock periods (but less than one row period), in order to allow time for at least one bit of check data to arrive and be checked, before the payload data is used. As a further alternative, the data may be deliberately delayed by more than one bit clock periods, and possibly more than one row period, to allow multiple check bits to be processed, and for the payload data to be verified before it is used.

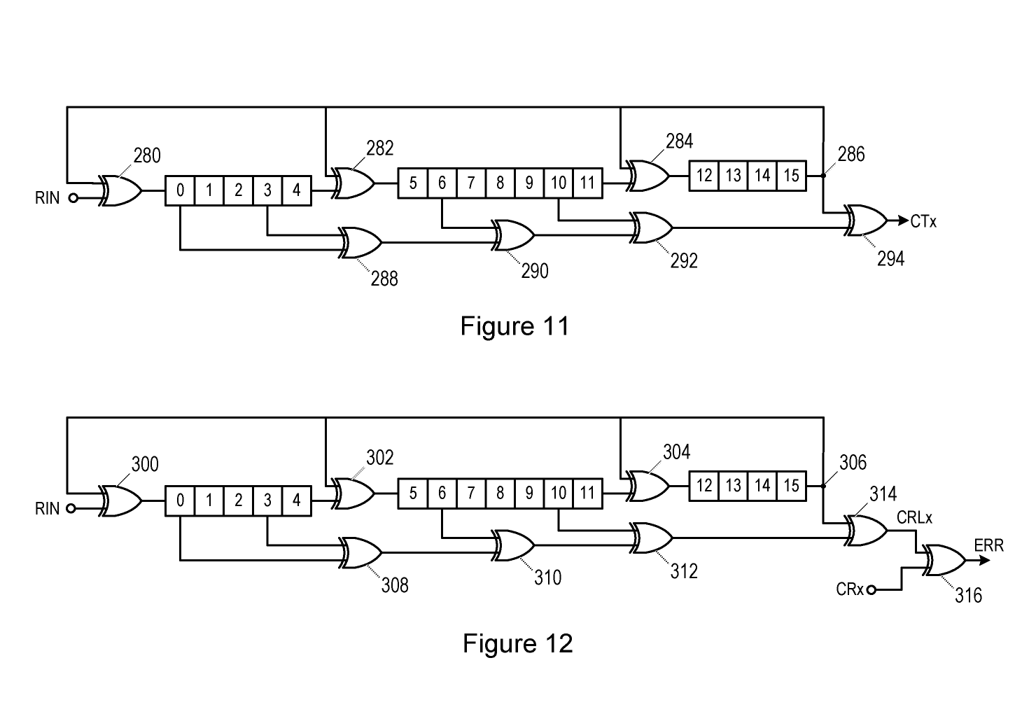

FIG. 11 illustrates the form of the Redundancy Code Generator block 170 on the transmit side.

In this example, the Redundancy Code Generator block 170 is based around a Cyclic Redundancy Check code generator. Thus, input data RIN is supplied to a first input of a first XOR gate 280, and, as the block is clocked, the output of the first XOR gate 280 is shifted through the first five blocks (numbered 0-4) of a shift register. The output of the fifth block (numbered 4) of the shift register is supplied to a first input of a second XOR gate 282. The output of the second XOR gate 282 is shifted through the next seven blocks (numbered 5-11) of the shift register. The output of the twelfth block (numbered 11) of the shift register is supplied to a first input of a third XOR gate 284. The output of the third XOR gate 284 is shifted through the next and final four blocks (numbered 12-15) of the shift register. The output of the sixteenth block (numbered 15) of the shift register appears at an output 286.

The bit appearing at the output 286 is fed back to the second inputs of the XOR gates 280, 282, 284.

The bit values in the first and fourth blocks (numbered 0 and 3) of the shift register are applied to the inputs of a fourth XOR gate 288. The output of the fourth XOR gate 288 and the bit value in the seventh block (numbered 6) of the shift register are applied to the inputs of a fifth XOR gate 290. The output of the fifth XOR gate 290 and the bit value in the eleventh block (numbered 10) of the shift register are applied to the inputs of a sixth XOR gate 292. The output of the sixth XOR gate 292 and the bit value at the output 286 of the shift register are applied to the inputs of a seventh XOR gate 294. Thus, the fourth to seventh XOR gates 288, 290, 292 and 294 form the modulo-2 sum of the bit values in the first, fourth, seventh, eleventh and sixteenth blocks of the shift register.

The code generator generates code bits as the result of data bits applied sequentially at its input, where the code generator may be modelled by a set of uniquely identifiable discrete states which the code generator can reach as a result of a first input data sequence, where each said state of the code generator leads to a different series of generated code bits for one and the same sufficiently long second data sequence on the input of the code generator once the code generator has reached said state.

The check bits are therefore generated using a recursive convolution process, that is, a process in which parity symbols are generated by the sliding application of a Boolean polynomial function to a data stream, with a feedback structure.

In other embodiments the number of shift register stages or the connections of the XOR network may be different from that illustrated, such that a different polynomial function is used.

In contrast to (for example) just generating a parity bit on the basis of the last few input data samples and then resetting to generate a parity bit on the next few input data samples, in a recursive process the effect of an error persists for longer, and thus even if by chance the error is undetected at the first attempt, later check bits may also be affected. Thus there is a greater overall chance that an error may be detected. When such generated check bits are presented and checked soon after generation there is a better chance of detecting any error rapidly, allowing for mitigation of its effect, for example by muting the signal rather than generating a corrupted output signal.

A Redundancy Code Generator employing a recursive convolution process may be implemented in different ways than the shift register topology above. A Recursive Convolution Code Generator is generally a state machine in which the trajectory from one state to another is defined by the present state and the current input data bit. In principle the states and trajectories could be coded in a look-up table or implemented at least in part in software.

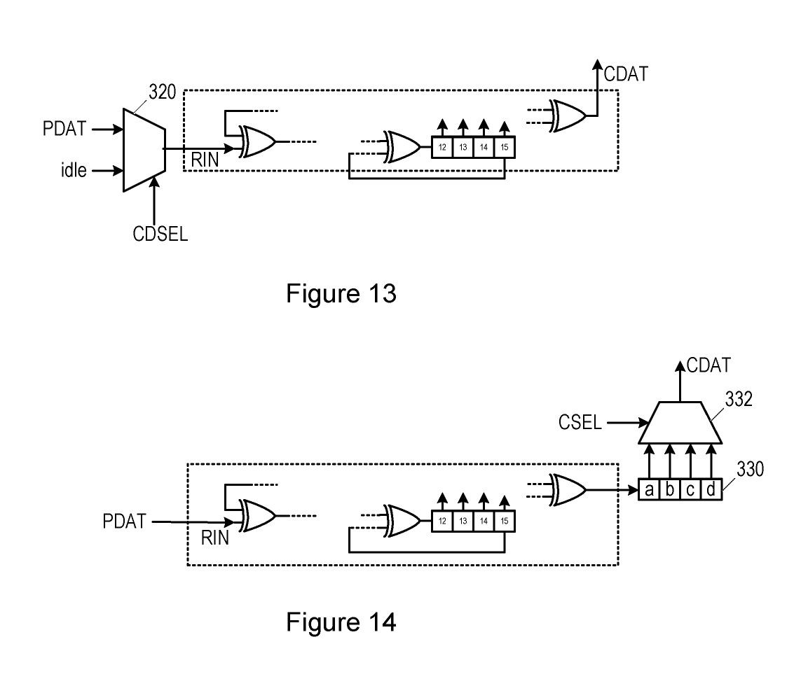

FIG. 12 illustrates the form of the Redundancy Code Generator block 182, and associated circuitry, on the receive side. This is very similar to the form of the Redundancy Code Generator block on the transmit side. Thus, the Redundancy Code Generator block 182 is also based around a Cyclic Redundancy Check code generator. Thus, input data RIN is supplied to a first input of a first XOR gate 300, and, as the block is clocked, the output of the first XOR gate 300 is shifted through the first five blocks (numbered 0-4) of a shift register. The output of the fifth block (numbered 4) of the shift register is supplied to a first input of a second XOR gate 302. The output of the second XOR gate 302 is shifted through the next seven blocks (numbered 5-11) of the shift register. The output of the twelfth block (numbered 11) of the shift register is supplied to a first input of a third XOR gate 304. The output of the third XOR gate 304 is shifted through the next and final four blocks (numbered 12-15) of the shift register. The output of the sixteenth block (numbered 15) of the shift register appears at an output 286.

The bit appearing at the output 306 is fed back to the second inputs of the XOR gates 300, 302, 304.

The bit values in the first and fourth blocks (numbered 0 and 3) of the shift register are applied to the inputs of a fourth XOR gate 308. The output of the fourth XOR gate 308 and the bit value in the seventh block (numbered 6) of the shift register are applied to the inputs of a fifth XOR gate 310. The output of the fifth XOR gate 310 and the bit value in the eleventh block (numbered 10) of the shift register are applied to the inputs of a sixth XOR date 312. The output of the sixth XOR gate 312 and the bit value at the output 306 of the shift register are applied to the inputs of a seventh XOR gate 314. Thus, the fourth to seventh XOR gates 308, 310, 312 and 314 form the modulo-2 sum of the bit values in the first, fourth, seventh, eleventh and sixteenth blocks of the shift register.

The check bits are therefore generated using a recursive convolution process, that is, a process in which parity symbols are generated by the sliding application of a Boolean polynomial function to a data stream, with a feedback structure.

As mentioned above in connection with the transmit side Redundancy Code Generator, in other embodiments the number of shift register stages or the connections of the XOR network may be different from that illustrated, such that a different polynomial function is used.

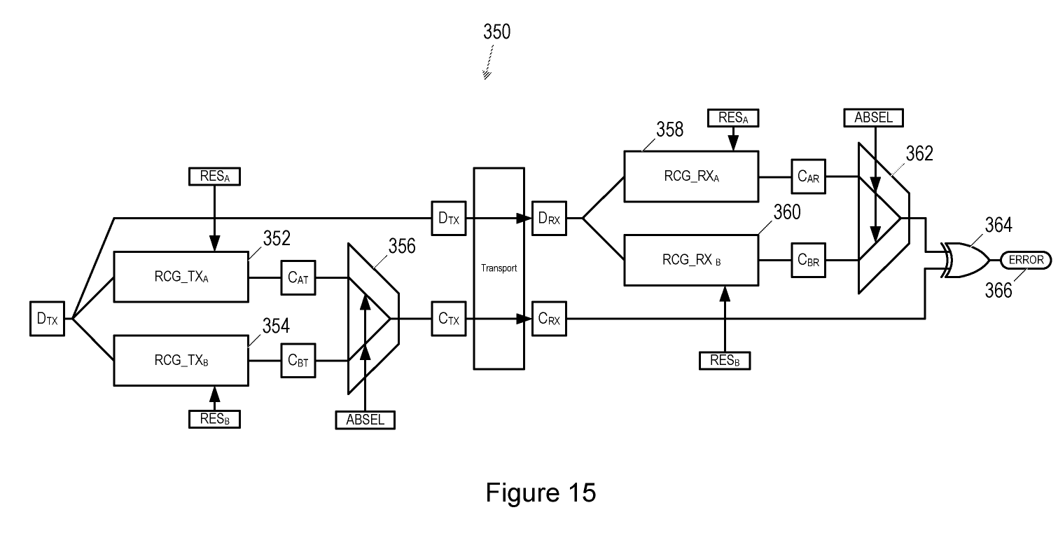

FIG. 13 illustrates one embodiment of circuitry for using the Redundancy Code Generator blocks 170, 182 to obtain the check data bits.

Considering the frame structure shown in FIG. 4, when there is a bit of payload data to be transmitted, or a bit of payload data has been received, that bit is applied as the input data RIN to the first input of the first XOR gate 280, 300 and the RCG circuitry is docked for each bit slot in the current row for which valid payload data PDAT is expected. In the subsequent bit slots when it is desired to generate a check data bit (either for transmission or for comparison with a received check bit), the input data RIN to the first input of the first XOR gate 280, 300 is set to a known value, which may for example be a fixed logic level (either 0 or 1), or a repeat of the last payload data bit value D, or its inverse, or a value from a known pseudo-random data stream.

This is achieved by applying the payload data PDAT to one input of a multiplexer 320, and by applying the known values to the other input of the multiplexer 320, and selecting the appropriate input using a selector signal CDSEL.

The RCG thus continues to be clocked to generate the required number of check bits, and the output of the XOR gate 294 is taken as the check data value, during each such bit period when it is desired to transmit a check data bit CDAT (which may be a CTx data bit in the case of the RCG 170 or a CLRx data bit in the case of the RCG 182 respectively).

The RCG clock may then be disabled until the arrival of new PDAT data in the next row. Thus the RCG is clocked both when there is valid PDAT data expected and in the configured number of subsequent check bit slots.

FIG. 14 illustrates an alternative embodiment of circuitry for using the Redundancy Code Generator blocks 170, 182 to obtain the check data bits.

In this case, in each row of the frame the configured number of bits of payload data PDAT are applied as the input data RIN to the first input of the first XOR gate 280, 300 and the RCG circuitry is clocked for each bit slot in the current row for which valid PDAT data is expected. The output values from the Redundancy Code Generator block 170, 182 are applied to a further shift register 330, which thus stores a last few (four in this example) outputs from the core of the RCG.

In the subsequent bit slots when it is desired to generate a check data bit (either for transmission or for comparison with a received check bit), the dock to the RCG may be disabled and the values a, b, c, d stored in the shift register 330 are applied to a multiplexer 332, while a selector signal CSEL determines which of the values a, b, c, d is output in turn as the check bit data CDAT during the configured number of check data bit slots in the current row.

Alternatively, the earliest value stored in the shift register 330 could be output, and the shift register 330 could continue to be clocked in order to generate new check data bits (up to four in number in this example) even though the shift register in the Redundancy Code Generator is no longer clocked.

As mentioned above, the generation of the check data bits in the receiver, and the comparison of these bits with the check data bits received from the transmitter, allows an error to be detected, when the decorrelation of the generated check data bits from the received check data bits leads to a difference in the bit sequences.

Thus, the receiving device can detect when there has been an error in the data transmission and can take action. However, one issue that arises is that, when an error has been detected, the RCG block 182 in the receiving device is no longer synchronized with the RCG block 170 in the transmitting device. In order to avoid any problem with this, in some embodiments, each of the RCG blocks contains multiple (for example, two) Redundancy Code Generators.

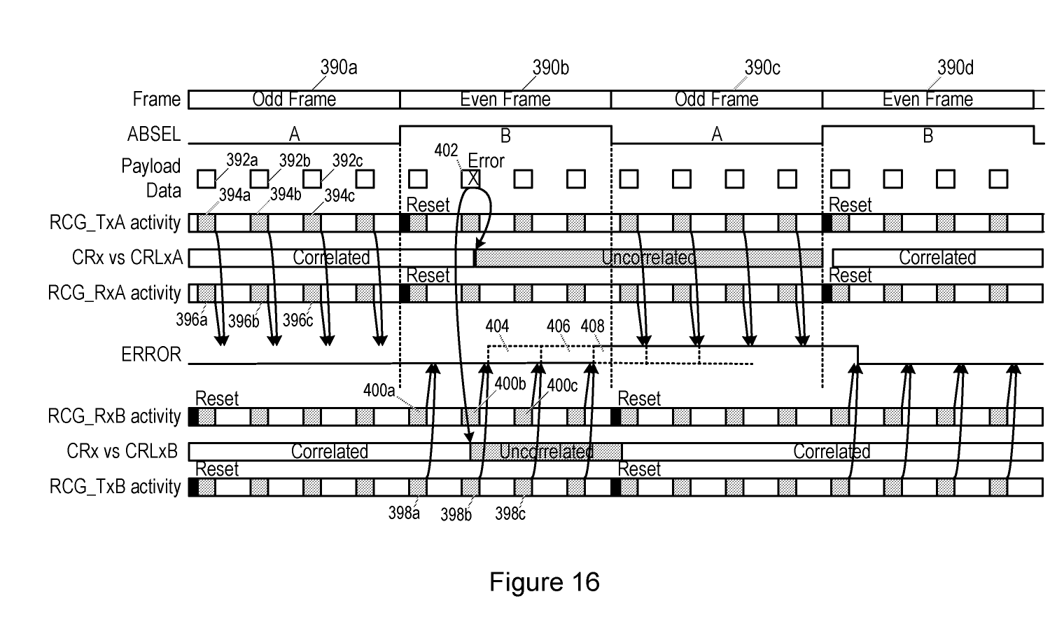

FIG. 15 illustrates a system 350 in which each of the RCG blocks contains two Redundancy Code Generators.

Specifically, FIG. 15 shows payload data DTX for transmission being applied to two Redundancy Code Generators 352, 354, namely RCG_TX_{A} and RCG_TX_{B}, which are each as described with reference to FIG. 11, but which also operate under the control of respective reset signals RES_{A} and RES_{B}, and generate respective check data bit streams C_{AT} and C_{BT}.

The check data bit streams C_{AT} and C_{BT} are applied to a multiplexer 356 and the output thereof, controlled by the selector signal ABSEL, provides the transmitted check data bit stream C_{TX}.

As described for example with reference to FIGS. 7 and 8, the check data bit stream C_{TX} is multiplexed with the payload data D_{TX} and transmitted to the receiver. In the receiver, as described for example with reference to FIGS. 9 and 10, the check data bit stream C_{RX} is demultiplexed from the payload data D_{RX}.

The received payload data D_{RX} is applied to two Redundancy Code Generators 358, 360, namely RCG_RX_{A} and RCG_RX_{B}, which are each as described with reference to FIG. 12, but which also operate under the control of respective reset signals RES_{A} and RES_{B}, and generate respective check data bit streams C_{AR} and C_{BR}.

The check data bit streams C_{AR} and C_{BR} are applied to a multiplexer 362 and the output thereof, again controlled by the selector signal ABSEL, provides the generated check data bit stream that is compared with the received check bit stream C_{Rx} in the XOR gate 364, with the result being applied to an error detection unit 366.

As described before, the detection of an error can then be used to modify the processing of the received data.

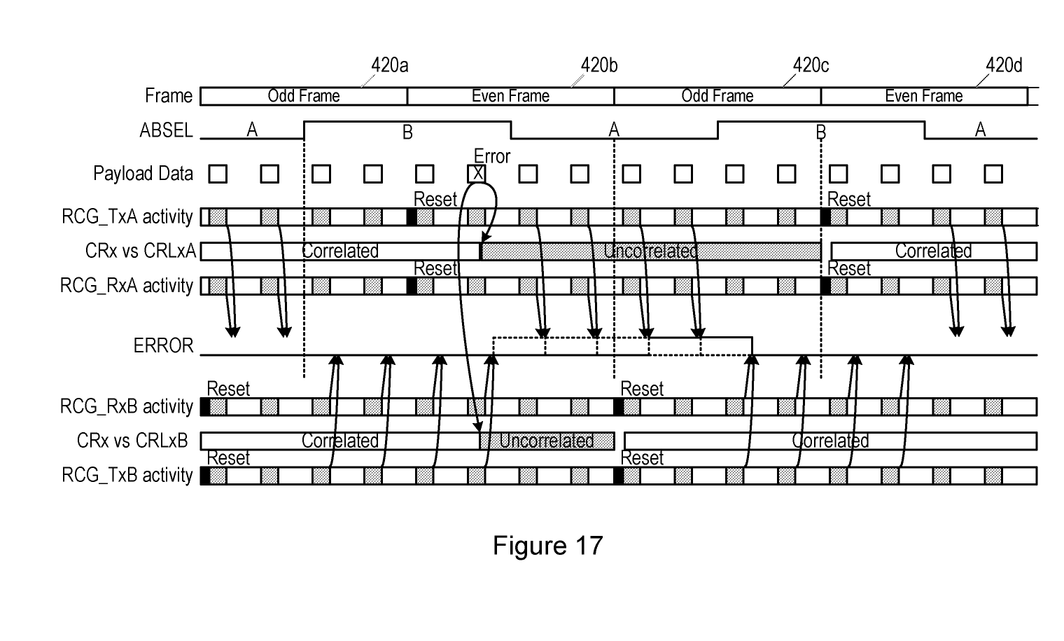

FIG. 16 illustrates the operation of the system of FIG. 15, in one embodiment, and in one example situation.

Specifically, FIG. 16 shows an example of the operation over several frames 390a, 390c, 390c, 390d, where frames are alternately denoted as Odd and Even, and where each frame includes 4 rows for the purposes of illustration, and each of these rows includes some payload data 392a, 392b, 392c, etc for transmission in the direction illustrated.

FIG. 16 shows the value of the multiplexer control signal ABSEL during each frame, showing that the check data bit stream C_{AT} is selected by the multiplexer 356 and the check data bit stream C_{AR} is selected by the multiplexer 362 during the Odd frames, while the check data bit stream C_{BT} is selected by the multiplexer 356 and the check data bit stream C_{BR} is selected by the multiplexer 362 during the Even frames.

Also, the Redundancy Code Generators 354 and 360, namely RCG_TX_{B} and RCG_RX_{B}, are each reset at the start of each Even frame, while the Redundancy Code Generators 352 and 358, namely RCG_TX_{A} and RCG_RX_{A}, are each reset at the start of each Odd frame. The resets may take place at any time while the device is not active, i.e. in any bit slot not used for transmitting (receiving) data in the relevant direction along the link. The resetting involves putting the registers or flip-flops constituting the RCGs into specific predefined states at predetermined times. This means that, even if there has been an error in the data transmission that means that the two RCGs become unsynchronized, this resetting brings them back into synchronization.

During the frame 390a, the Redundancy Code Generator 352 on the transmit side (RCG_TX_{A}) is active during each row, generating one check bit (in this illustrated example, although multiple check bits may be generated per row, as mentioned previously) 394a, 394b, 394c, etc, and its output is selected by the multiplexer 356. The Redundancy Code Generator 358 on the receive side (RCG_RX_{A}) is also active during each row, again generating one check bit 396a. 396b, 396c, etc per row, and its output is selected by the multiplexer 362.

The error detection block on the receive side compares the check bits CR_{X} received from the transmitter with the check bits CLR_{X}A from RCG_RX_{A}. When there have been no errors in the received data stream, the check bits CR_{X} and CLR_{X}A are correlated, and so the comparison shows that there has been no error.

During the frame 390b, the Redundancy Code Generator 354 on the transmit side (RCG_TX_{B}) is active during each row, generating one check bit (in this illustrated example, although multiple check bits may be generated per row, as mentioned previously) 398a, 398b, 398c, etc, and its output is selected by the multiplexer 356. The Redundancy Code Generator 360 on the receive side (RCG_RX_{B}) is also active during each row, again generating one check bit 400a, 400c, 400c, etc per row, and its output is selected by the multiplexer 362.

The error detection block on the receive side compares the check bits CR_{X} received from the transmitter with the check bits CLR_{X}B from RCG_RX_{B} When there have been no errors in the received data stream, the check bits CR_{X} and CLR_{X}B are correlated, and so the comparison shows that there has been no error.

However, FIG. 16 shows an error (marked by an X) in the transmission of one row 402 of payload data. From that point onwards, the check bits CLR_{X}B generated by RCG_R_{X}B at the receive side will become uncorrelated with the check bits CR_{X} received from the transmitter.

As illustrated at 404 and 406, the effect of this is that the subsequent check bits CLR_{X}B generated by RCG_RxB at the receive side may be equal to the check bits CR_{X} received from the transmitter, or may be different. When a check bit CLR_{X}B generated by RCG_RxB at the receive side is first unequal to the corresponding check bit CRₓ received from the transmitter, illustrated at 408, the error detection block in the receiver sets a flag, which is latched, and the subsequent processing of the received data is handled appropriately.

At the end of frame 390c the multiplexers change state so that the transmitted check bits CTX are generated by RCG_TXA and the locally generated receiver check bits are generated by RCG_RXA. The outputs of these generators were also decorrelated after the data error event, and so there is no reason to reset the error flag—there may in fact still be further data errors occurring as far as can be determined by the comparison of the check bit sequences.

FIG. 16 also shows that the Redundancy Code Generators 354 and 360, namely RCG_TX_{B} and RCG_RX_{B}, are each reset at the start of frame 390c, and that, as a result, RCG_TX_{B} and RCG_RX_{B} are brought back into synchronization, and the check bits CR_{X} and CLR_{X}B are correlated throughout the frame 390c, and remain correlated until there is any further error. However it is still possible that the first few bits may be matched by chance, even in the presence of further errors, so it is prudent to wait for several further bits to make sure. In this example, the check bits CR_{X} and CLR_{X}B are not selected by the multiplexers for use in comparison until the end of this frame 390c.

At this point, after handover to the “B” generators, the Redundancy Code Generators 352 and 358, namely RCG_TX_{A} and RCG_RX_{A}, are each reset at the start of frame 390d, ready to be used at the end of the next frame after 390d.

The switching of the streams using the multiplexers 356 and 362 means that Redundancy Code Generators on the transmit and receive sides can be brought back into synchronization after an error, allowing subsequent errors to be detected by a frame period after the first reset after the last detected error.

In contrast to some other error detection schemes, the Redundancy Code Generator is not reset every row while actively being used to generate or validate check bits: the state of the Redundancy Code Generator is preserved from one row to another while active, despite any dead period in which data is not transmitted in a particular direction. Thus check bits generated in later rows are still sensitive to errors that may have occurred in earlier rows. Thus even if an error is missed by chance on the first check bits to be compared, there is a good chance the error will be detected by later check bits. The periodic reset every two frames occurs when it is not being used for actual data error detection, and it is not so used until after a delay adequate for it to receive and process significant input data information.

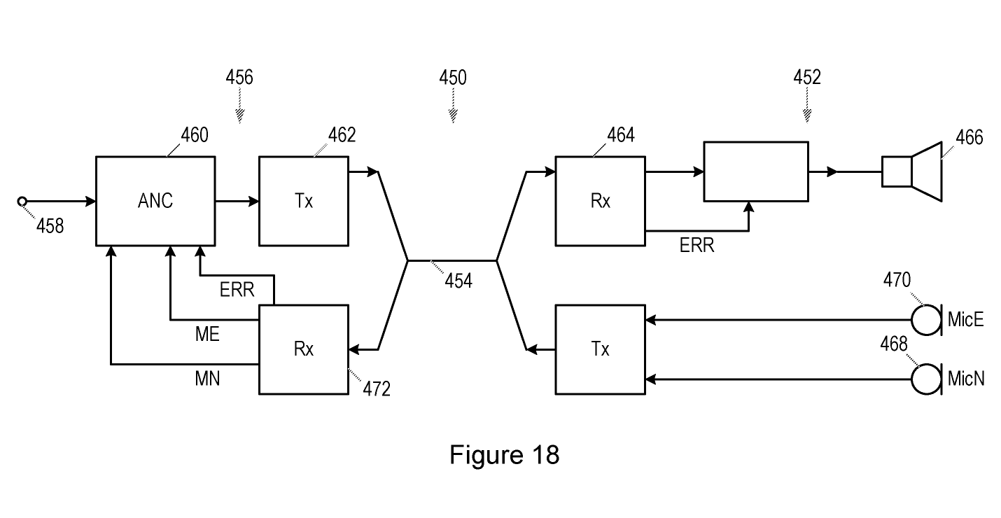

FIG. 17 illustrates the operation of the system of FIG. 15, in one alternative embodiment, and in one example situation.

Specifically, FIG. 17 shows an example of the operation over several frames 420a, 420c, 420c, 420d, where frames are alternately denoted as Odd and Even, and where each frame includes 4 rows for the purposes of illustration, and each of these rows includes some payload data for transmission in the direction illustrated.

FIG. 17 shows the value of the multiplexer control signal ABSEL at all times, showing that the check data bit stream C_{AT} is selected by the multiplexer 356 and the check data bit stream C_{AR} is selected by the multiplexer 362 during the first half of each Odd frame and the second half of each Even frame, while the check data bit stream C_{BT} is selected by the multiplexer 356 and the check data bit stream C_{BR} is selected by the multiplexer 362 during the second half of each Odd frame and the first half of each Even frame.

The Redundancy Code Generators 354 and 360, namely RCG_TX_{B} and RCG_RX_{B}, are each reset at the start of each Odd frame, while the Redundancy Code Generators 352 and 358, namely RCG_TX_{A} and RCG_RX_{A}, are each reset at the start of each Odd frame. As before, the resets may take place at any time while the device is not active, i.e. in any bit slot not used for transmitting (receiving) data in the relevant direction along the link. The resetting involves putting the registers or flip-flops constituting the RCGs into specific predefined states at predetermined times. This means that, even if there has been an error in the data transmission that means that the two RCGs become unsynchronized, this resetting brings them back into synchronization.

Thus, the operation shown in FIG. 17 is generally similar to that illustrated in FIG. 16, except that the RCGs are reset at a substantially different time to the commutation of the multiplexer control ABSEL, in this case approximately half a frame period afterwards. Thus for example the “B” RCG generators are used to supply the check bits only half a frame period after being reset after the error occurred rather than a full frame period afterwards. Thus the error flag may be able to be reset half a frame earlier on average than in the case of the multiplexer timing illustrated in FIG. 16.

In further variations, the multiplexer timing may be advanced even further towards the reset event timing. However then the probability that the matching of the check bits is due to a correlation by chance of the check bits in the presence of data errors may become higher than desired.

FIG. 18 illustrates an ambient noise cancellation (ANC) headset system 450 operating in accordance with aspects of the invention and comprising a headset 452 connected by a headset cable 454 to ANC processing in a host apparatus 456. The host apparatus may for example be a computing device such as a smartphone or may be a dangle on the headset cable, located between the headset and a connector for connection to apparatus such as a phone.

An audio signal source 458 supplies audio data, for example music stored in the device or telephony speech, which is passed via an ANC processor 460 (which may also apply other signal processing, for example equalisation) to a transmitter block 462 and then down the cable 454 to a receiver 464 in the headset 452, which extracts data to be rendered by a speaker 466 in a headphone cup or earbud of the headset. External noise is monitored by a noise microphone MicN 468 and the signal inside the ear cavity is monitored by an error microphone MicE 470. The signals from these two microphones are multiplexed and passed up the cable 454 to a receiver 472 in the host apparatus. The receiver 472 separates out respective microphone signals MN and ME, which are then input into the ANC processing block 460, (In some embodiments the ANC may be purely feed-forward or purely feedback, so only one microphone or microphone signal may be used).

The data may be transmitted up and down the link according to the invention in a half-duplex fashion in a frame format comprising check bits.

If an error is detected in the link up from the headset 452 to the host device 456, the ANC operation may be modified to avoid generating spurious signals. For instance the adaptation of any adaptive filter in the ANC processor 460 may be halted and/or the external noise signal may be attenuated in some graceful way. The ANC processor 460 may still continue to transmit audio data up to the headset, but may no longer be attempting to correct for external noise.

The robustness of the link down from host device to headset is monitored in the headset, and if an error is detected in that direction of transmission, the speaker signal may be muted in some graceful way, for example gradually ramped down from its last value.

In this way, the effects of data errors, due for example to a burst of external electromagnetic interference, may be managed separately and locally in each direction to expeditiously manage the impact on the system. If the interference only causes actual data corruption in the link from the headset to the host device, then at least the initial audio signal can still be heard by the user. If the interference only causes errors in the link up to the headset, the noise microphone signal may still be used by the ANC circuitry.

In some embodiments, the occurrence of errors in one direction may also be communicated via control data transmitted down the same wired link in the opposite direction, for example to warn the ANC processor that the speaker data has been corrupted on receipt at the headset and to thus disregard the error microphone signal, e.g. by halting ANC filter adaptation.

As described so far, it is intended that a transmitter should transmit the check bit data in a form that will be used by a receiver for checking purposes. However, the system is backwards compatible, in that the proposed operation and frame structure is such that the check bits appear simply as another data stream allowing easy configuration of compatible operation. Thus, a receiver without the RCG-based checking capability could be configured in use to just ignore this data stream from an RCG transmitter, just like any other (audio) data stream. Alternatively, a receiver with RCG capability could be configured to disable the error checking (e.g., during initialisation of the link) and indeed accept real audio data down this channel/bit-slots if the transmitter is not able to generate the checking data, or if an RCG-capable transmitter is configured to operate in a “legacy” noon-RCG mode even with a RCG-capable receiver.

The skilled person will thus recognise that some aspects of the above-described apparatus and methods, for example the calculations performed by the processor may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware

Embodiments of the invention may be arranged as part of an audio processing circuit, for instance an audio circuit which may be provided in a host device. A circuit according to an embodiment of the present invention may be implemented as an integrated circuit. One or more loudspeakers may be connected to the integrated circuit in use.

Embodiments may be implemented in a host device, especially a portable and/or battery powered host device such as a mobile telephone, an audio player, a video player, a PDA, a mobile computing platform such as a laptop computer or tablet and/or a games device for example. Embodiments of the invention may also be implemented wholly or partially in accessories attachable to a host device, for example in detachable speakerphone accessories or external microphone arrays or the like. The host device may comprise memory for storage of code to implement methods embodying the invention. This code may be stored in the memory of the device during manufacture or test or be loaded into the memory at a later time.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope. Terms such as amplify or gain include possibly applying a scaling factor of less than unity to a signal.

1. A data transmitter for transmitting multiple payload data streams in a frame format, wherein each frame comprises multiple rows, and each row comprises multiple bit slots, the data transmitter comprising:
configuration storage circuitry, for storing frame format configuration data;
an input, for receiving the multiple payload data streams;
data multiplexing circuitry, for combining the multiple payload data streams in accordance with the stored frame format configuration data to form a combined payload data stream; and
redundancy code generator circuitry, for receiving the combined payload data stream, and generating check bit data therefrom;
wherein the data multiplexing circuitry is further configured for multiplexing the combined payload data stream and the check bit data into data for transmission in said frame format.

2. A data transmitter as claimed in claim 1, wherein the data multiplexing circuitry is further configured for multiplexing the combined payload data stream and the check bit data with at least one check bit in each row of the frame.

3. A data transmitter as claimed in claim 1, wherein the data multiplexing circuitry is further configured for multiplexing the combined payload data stream and the check bit data into data for transmission, such that data of the multiple payload data streams appears at positions in the frame, as determined by the stored frame format configuration data.

4. A data transmitter as claimed in claim 1, wherein the redundancy code generator circuitry is configured for generating the check bit data from the combined payload data stream by a recursive convolution process.

5. A data transmitter as claimed in claim 1, wherein the redundancy code generator circuitry is clocked only once for each bit of the combined payload data stream, with generated check bits being stored until they are multiplexed into the data for transmission.

6. A data transmitter as claimed in claim 1, wherein the redundancy code generator circuitry is clocked once for each bit of the combined payload data stream and once for each required check bit, with generated check bits being multiplexed into the data for transmission immediately on generation.

7.-8. (canceled)

9. A data transmitter as claimed in claim 1, wherein the frame format comprises synchronization bit slots, control data bit slots, and bits slots for receiving data during each row.

10. A data transmitter as claimed in claim 9, comprising a clock recovery circuit for recovering a clock from received data.

11.-12. (canceled)

13. A data receiver for receiving data in a frame format, wherein each frame comprises multiple rows, and each row comprises multiple bit slots, the receiver comprising:
configuration storage circuitry for storing frame format configuration data;
data selection circuitry, for extracting payload data and received check bit data from the received data according to the stored frame format configuration data;
a redundancy code generator, for generating from the payload data a stream of locally generated check bit data; and
data error checking circuitry, for comparing the locally generated check bit data with the extracted received check bit data, and for generating an error flag if the comparison identifies a difference between the locally generated check bit data and the extracted received check bit data.

14. A data receiver as claimed in claim 13, wherein the data selection circuitry is further configured for extracting at least one check bit from each row of the frame.

15. A data receiver as claimed in claim 13, wherein the data selection circuitry is further configured for extracting the multiple payload data streams from the combined payload data stream, and the multiple payload data streams appear at positions in the frame, as determined by the stored frame format configuration data.

16. A data receiver as claimed in claim 13, wherein the redundancy code generator circuitry is configured for generating the check bit data from the combined payload data stream by a recursive convolution process.

17. A data receiver as claimed in claim 13, wherein the redundancy code generator circuitry is clocked only once for each bit of the combined payload data stream, with generated check bits being stored until they are multiplexed into the data for transmission.

18. A data receiver as claimed in claim 13, wherein the redundancy code generator circuitry is clocked once for each bit of the combined payload data stream and once for each required check bit.

19. A data receiver as claimed in claim 18, wherein a known data value is input into the redundancy code generator circuitry during each bit period when a check bit is required.

20.-21. (canceled)

22. A data receiver as claimed in claim 13, comprising a clock recovery circuit for recovering a clock from received data.

23.-24. (canceled)

25. A data receiver as claimed in claim 13, wherein the receiver outputs the extracted payload data for processing, and wherein the processing is controlled in response to generation of an error flag.

26.-28. (canceled)

29. A data receiver as claimed in claim 13, wherein the receiver outputs the extracted payload data for processing, and wherein the processing is performed with a deliberate delay of at least one bit clock period to allow for comparing at least one bit of the locally generated check bit data with the extracted received check bit data before the processing.

30. A data receiver as claimed in claim 29, wherein the receiver outputs the extracted payload data for processing, and wherein the processing is performed with a deliberate delay of at least one row period to allow for comparing multiple bits of the locally generated check bit data with the extracted received check bit data before the processing.

31. A data transmission system, comprising:
a data transmitter for transmitting multiple payload data streams in a frame format, wherein each frame comprises multiple rows, and each row comprises multiple bit slots, the data transmitter comprising:
configuration storage circuitry, for storing frame format configuration data;
an input, for receiving the multiple payload data streams;
data multiplexing circuitry, for combining the multiple payload data streams in accordance with the stored frame format configuration data to form a combined payload data stream; and
redundancy code generator circuitry, for receiving the combined payload data stream, and generating check bit data therefrom;
wherein the data multiplexing circuitry is further configured for multiplexing the combined payload data stream and the check bit data into data for transmission in said frame format; and
a data receiver for receiving data in a frame format, wherein each frame comprises multiple rows, and each row comprises multiple bit slots, the receiver comprising:
configuration storage circuitry for storing frame format configuration data;
data selection circuitry, for extracting payload data and received check bit data from the received data according to the stored frame format configuration data;
a redundancy code generator, for generating from the payload data a stream of locally generated check bit data; and
data error checking circuitry, for comparing the locally generated check bit data with the extracted received check bit data, and for generating an error flag if the comparison identifies a difference between the locally generated check bit data and the extracted received check bit data;
wherein the data transmitter and the data receiver are coupled by a wired link.

32.-57. (canceled)
